(19) United States
(12) Patent Application Publication
(10) Pub. No.: US 2017/0239111 A1
(43) Pub. Date: Aug. 24, 2017

(54) UNIVERSAL SECURING MECHANISM FOR WHEELED MOBILITY SYSTEMS OR SIMILAR SYSTEMS AND RELATED POSTURAL SUPPORTS

(71) Applicant: PRODUCTOS DE APOYO PARA EL SENTADO CONFORTABLE, SENCON SAS, Cali (CO)

(72) Inventors: David HURTADO MATINEZ, Cali (CO); Rory A. COOPER, Pittsburg, PA (US); Manhender Arjun MANDALA, Pittsburg, PA (US); Genevieve M. JEROME, Pittsburg, PA (US); Joshua TELSON, Pittsburg, PA (US); Maria Luisa TORO HERNANDEZ, Pittsburg, PA (US)

(21) Appl. No.: 14/898,090

(22) PCT Filed: Jun. 12, 2014
(86) PCT No.: PCT/IB2014/062172

§ 371 Date: Aug. 27, 2016

(30) Foreign Application Priority Data
Jun. 13, 2013 (CO) 13-141896

(51) Int. Cl. A61G 5/10; A47B 23/02; A47C 21/00; A47B 1/04; A47C 7/70

(52) U.S. Cl. CPC A61G 5/1094; A61G 5/10; A47B 1/04; A47C 7/70; A47C 21/00; A47B 23/025; A61G 2203/78

(57) ABSTRACT

This subjecting mechanism is a versatile mechanism which allows to locate different postural supports or accessories such as lap-tray desks, umbrellas, fishing rods and virtually any other desired accessory, in various points of a mobility system on wheels or on rest, with easy fastening and release. It allows to locate the postural supports in accordance to the user's need with more than two degrees of freedom. The subjecting mechanism may work as a unit or in combination with two or more clamps for more stability, and may even be fastened with belts or lariats that bring other points of support. The connecting postural supports present in this invention are modular structures, where the base of the structure may be smooth, with setoff or a protrusion net lower part, lending support to all the upper limbs to perform different manual activities.

### FIELD OF THE INVENTION

This development involve industrial design and mechanical engineering fields, specifically the design and manufacture of support and adjustment systems, particularly on dynamic systems. For example, systems for subjecting or fastening structural elements or parts of joint machines; cloves, screws, staples, clips or wedges, articulations or unions, shaft couplings, support for pipes, cables or protection tubes hangers, supports, clamps, clips and other universal brackets, particularly with movement that allows a special disposition of a tube or pole.

### BACKGROUND

During the phases of comparative evaluation of the design process, many patents on lap trays and similar devices were examined. The majority of the existing lap trays requires the wheelchair armrests as the main element to secure the device.

The state of the art describes various mechanisms which allow different devices such as lap trays, oxygen pipes, postural supports, orthotic devices, exoskeleton and others to be adjusted to the tubes of the wheelchair. However, those mechanisms work holding the devices in a fixed position, by being screwed to the wheelchair or with fixed settings. PRYOR et al (1984) developed an accessory to adapt oxygen bottles, intravenous solution containers and other medical accessories, which includes a post or lower tube that is vertically extended to be fixed in a detachable way to the rear of a wheelchair, in a position that allows the crease of the chair and which includes a post or superior enlargeable tube which extends vertically and in which the accessories may be disposed of.

However, said accessory only connects one tube of the wheelchair with other tube in a parallel way and does not allow the degrees of freedom that the technology described in this document allows. Moreover, the Pryor device does not seem to offer ease of grasping by the user.

QUICKIE DESIGNS INC, Steven et al., (1993) developed a mountable inverted U-shaped armrest ensemble to a wheelchair. This system consist of two perpendicular posts or tubes that are very easy to install and uninstall, and permits the adjustment of the distance.

However, the substantial difference with the technology described in this document is that the clamp mechanism allows adjusting to any tube diameter, including a case in which the tube is beaded by the canvas of the backrest or the seat. As it can be plainly seen in the Stevens patent, the artifact may only be installed in specific tubes of the wheelchair, thus not qualifying for a universal status.

ROBERTS et al (1994), developed a wheelchair with a turning tray that can rotate in a support member, from a first frontal position to a back position. In an alternate position of the turning tray, the tray rotates from a first position which is generally parallel to the armrest, ninety degrees in a vertical position, which helps the wheelchair user be more comfortable.

However, the invention only works for parallel posts or tubes. Likewise, the clamp connects using a much more complex system, in an almost permanent form. GOSCHY et al (2006) designed a support/table, which is easily fittable in a wheelchair without any need of perforations or weldings. The design may hold an electronic device such as a computer or simply provide a work surface for reading or feeding. It may be set up in the frame of the wheelchair or in a tube that may be inserted in the footrest. The design consists of six main elements: 1. Desk assembly, 2. Upper support assembly, 3. Lower support assembly, 4. Standard clamp of lower assembly, 5. Short subjection tube and standard clamp of outer assembly.

However, this design is much more complex for installation, for instance, the use of the additional tool for its installation and the help of a third party or the need of the wheelchair user to get off the wheelchair. The significant advantage of our mechanism is that it allows to be installed in any part of the wheelchair by the user thanks to its easy apprehension system and its hook configuration.

SPECMAT LIMITED (2008) developed an apparatus to connect two objects. The first object includes a body of fixation to a first object with a concave surface and a corresponding convex surface. The second one is a clamp for the fixation of a second object which has a first clamp and a second mobile clamp in relation to the first clamp. The first and second clamps are set-up to be respectively coupled to the concave and convex surfaces of the body when there is subjection to it, in which at least one clamp comprises at least one set-up tooth to bite in the body, applying the subjection strength. Likewise, it describes a chair, particularly a wheelchair for physically impaired persons, which has one or more armrests set-up to the apparatus as previously explained.

However, it is clear that this subjection system only works for parallel tubes in which it is subjected and does not allow the kind of freedom that our described mechanism offers. BLUE SKY DESIGNS, Goodwin et. al. (2007) describes an apparatus which may be set-up unto a wheelchair or unto similar devices. This apparatus includes a base unit, a series of armors which define the length of the apparatus, a number of rotable articulations and a support platform of one or more objects. The series of rotable articulations have a blocking system that allows the apparatus to obtain the desired spatial configuration. The blocking and unblocking mechanism allows one person to perform the function with just one hand.

Unlike the technology described by Goodwin, our technology offers a spatial positioning for devices with less mechanical components. Which constitutes a technical advantage at the time of set-up and maintenance, as well as easier interaction with the user. We can denote that the inventors of this technology have in mind the users of electric wheelchairs, who do not have much freedom for movement of their hands and require help of third parties.

Bonjour et al (2010) designed an apparatus to subject the footrest of a wheelchair when it is not in use. The apparatus comprises a first element which has a central portion that is substantially flat and an arched portion formed in each side of it. A second element which has a substantially identical form to that of the first member and is attachable with the first member in the central flat portion. Such arched portions form a clamp on a first end of the substantially flat central portion and form a clamp on the opposite end of the flat part, such clamp has proportions of an arch formed on an outer edge for the attachment with the abovementioned footrest. It counts with screws. It counts with a disposition of nut and bolt to fix the apparatus to the back post of the wheelchair in vertical position.

However, this proposed development only allows to subject tubes in a parallel position, and it does not fasten a second tube easily. Also, it does not easily fasten a second tube. Quality Enabling Devices (UK) developed a clamp that is distributed commercially and allows adjusting the angle of a movable rod or pole in two planes, one characteristic that may be applied only in a few wheelchair designs. Such clamp adjusts just like any other standard clamp, with the assembling of “jaws” of the subjection clamp, fixing itself in any of the angles in relation to the support. After the clamp is fixated, the mobile rod or pole may be positioned and fixated with a screw placed for this purpose.

The Wamilton Robotics Exoesqueleton (WREX) is a device which is commercially available by Jaeco Orthopedics Inc and is a licensor of the Neumor Foundation patent U.S. Pat. No. 6,821,259, however, the patent does not describe the mechanism of subjection to the wheelchair that they are currently using. As it can be seen in the corresponding images, this mechanism adjusts to the tube in the backrest and by a series of links which are installed to the first clamp it achieves the desired configuration for the passive orthotic of the arm.

This mechanism presents a disadvantage when compared to our invention, since it requires the apparatus to be screwed to the wheelchair through another person (as may be observed in their user manuals) and such subjection is permanent.

In general, the above described mechanisms which are part of the state of the art allow the mechanical subjection of the postural supports, staying fixed to the wheelchair or similar systems permanently. Also, most of the previous technologies found present an adjustment and allows a maximum of 1 or 2 degrees of freedom, which restrict the position and rotation of the postural support or accessory aid to the wheelchair. Furthermore, these technologies have not seem made to wheelchair users which are independent in their daily lives because it is evident that they have to be installed or fixated with the help of third parties. Certain mechanisms that bring more than 3 degrees of freedom present a larger complexity in their manufacture and assemble because they contemplate a great quantity of devices, which raises the costs.

It is obvious, then, that the state of the art is lacking of a device that allows, in more than 2 degrees of freedom, the subjection of postural support assisting technology devices in various points of a wheelchair. This device should be easier for fastening and release giving a comfortable position for the user, by allowing the installation in any tube and any type of wheelchair, preferably of wheelchair users that are independent and require devices which they can easily install by themselves. Moreover, their manufacture and assemble contemplate technical facility and a lesser number of components in order to achieve a more economic production.

### DESCRIPTION OF THE DRAWINGS:

FIG. 1 features of an exploded-view drawing of the set, which comprises the universal securing mechanism (100), where the following are exposed:

(1) Securing mean

(2) Mean to regulate the pressure

(3) Tubular mean

(4) First tubular brace with elongated projection

(5) Optional means to regulate pressure

(6) First tubular brace with elongated projection,

(7) Connecting mean

(8) Support mean to accessories

(9) Optional means to regulate pressure

FIG. 2 features all the assembled components of the universal securing mechanism (100), namely all the same means one (1) to nine (9), which are shown in FIG. 1.

FIG. 3 shows another embodiment of the first tubular brace with elongated projection (4) and a first tubular brace with elongated projection (6), where the elongated projections represents a higher elongation and in the distal end contemplate a few interlaced double ratchet means (10 and 11).

FIG. 4 exemplifies an easy-open lever as an embodiment of optional mean to graduate pressure (9).

FIG. 5 shows the universal securing mechanism fastened in different tubes of a wheelchair.

FIG. 6 shows instructions to place an accessory through the installation of the universal securing mechanism proposed in the tube of the back of a wheelchair.

FIG. 7 shows a set of possible accessories installed in the postural supports attached to a wheelchair through the universal securing mechanism in its different possible angles.

FIG. 8 features the universal securing mechanism (100) fastened to resting systems similar to those with mobility on wheels, such as desks or gurneys.

FIG. 9 features the universal securing mechanism (100) with a third elongated projection (10) which connects the first tubular brace elongated projection (4) and the first tubular brace with elongated projection (6).

FIG. 10 shows the universal securing mechanism (100) installed in the backrest of a wheeled mobility system and fastened to the armrest by means of belts or lariats.

FIG. 11 shows a complete table as a postural support positioned by two universal securing mechanism (100), located in the tube of each side of the backrest.

FIG. 12 shows the surface of two ways of realization of the related postural support, one with a smooth surface and another with a meshed lower part.

### DETAILED DESCRIPTION OF THE INVENTION

In different embodiments, the present release describes a subjection mechanism which allows to locate different accessories, such as lap-tray desks, umbrellas, fishing rods, among others, with at least five degrees of freedom with two links, and even more than five degrees of freedom depending on the number of links present. It allows an easier fastening and a low costs manufacturing process.

For a better understanding of the invention, it defines some of the terms hereby used. Nevertheless, such terms are more thoroughly defined by reference to the document as a whole. The units, prefixes and symbols may be denoted in their form of the International System (IS), which are widely accepted. “Wheeled mobility systems”, as used in this document, are any device or furnishing used by a physically impaired person, and which uses a running system (like wheels or caterpillar traction). This wide spectrum comprises manual wheelchairs, sports wheelchairs, bariatric wheelchairs, electric wheelchairs, scooters, gurneys with wheels, wheelchairs with stand-up functionality, and other similar devices. Moreover, “rest systems” should be understood as an extension of the concept of wheeled mobility systems, which may be devices or furnishes that are similar to the wheeled mobility system but without traction mechanisms (static). In that sense, the resting systems may use tables, gurneys, sofas and other similar furnishes. Thereinafter in this document, a wheelchair could be an example of mobility system or resting system.

“Postural support”, as used in this disclosure is a device used in a wheelchair that provides a better posture for the user in different positions; sitting down, laying down or standing up. Lap-tray desks, footrest, headrest, orthotics of upper or lower limbs, among others, are examples of postural supports. As an expansion on the concept, the postural supports can be understood as some “accessories”. Such accessories are structures that can be used in other devices. In that sense, any aid or accessory for the computer, cell phone, tablet, basket, umbrella, among others, are included in the concept described here. Based on this, an example of a postural support or accessory for a lap-tray desk, may be any of the abovementioned devices.

In this sense, in accordance to the shortcomings or opportunities that have been identified in the state of the art, the invention aims to supply the following identified needs during the design of the subjection mechanism:
The User needs to fasten accessories in various points of the wheelchair.
The subjection mechanism must be easy to install and uninstall for the wheelchair user (for instance, it should not contain means that are too complex), or at least should not require largely help from third parties.
It may adapt to different devices of postural support (for example: armrests, arm orthotics, lap trays, headrests, etc.).
The angles and average distance in relation to the user's seat should be adjustable for their comfort.
It should have at least six degrees of freedom (three degrees of rotation and three degrees of displacement).
It should be manufactured at low costs in order to have competitive prices in developing countries (China and South America).
It should be manufactured using methods and materials which are easily available in developing countries.

Multiple designs and alternatives were considered and modified before the final concept was determined. The first models were rejected because they did not incorporate all the needs pointed out above. Adjustability was the main aspect to be taken into account for these designs in order to develop the final version that inspires the original concept of this invention.

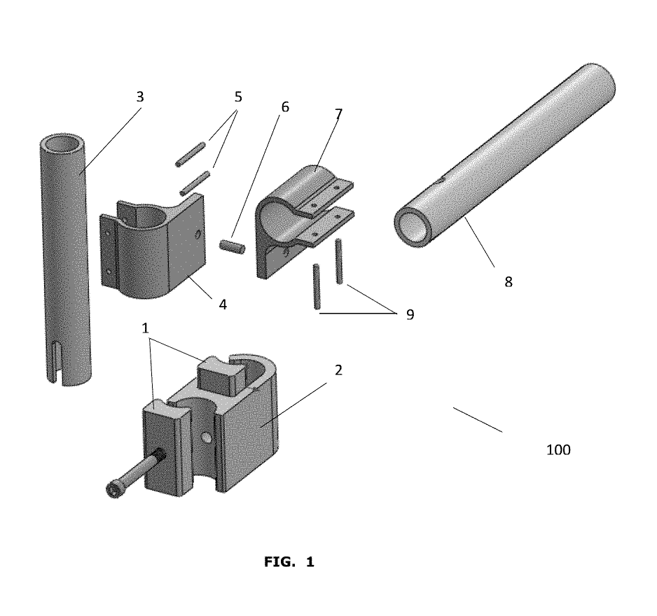

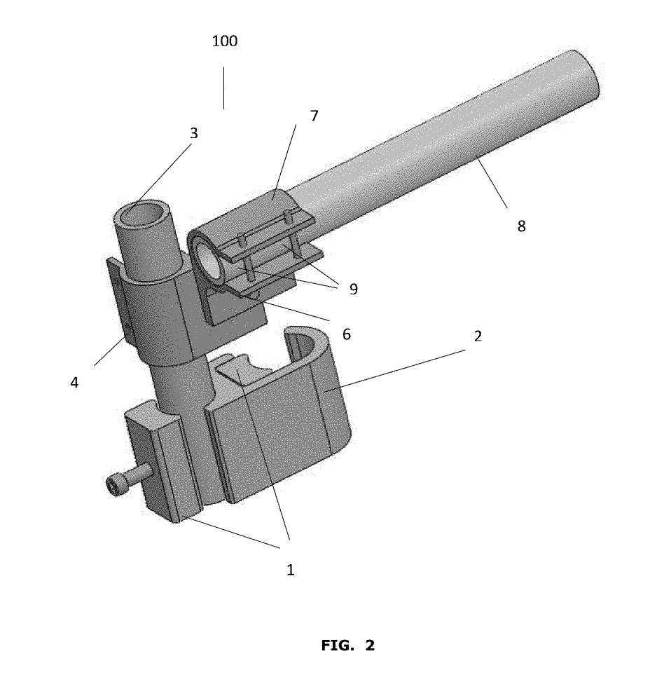

FIG. 1 describes one preferred embodiment of the invention. In this preferred embodiment, the invention comprises one securing mean (1) which can rotate and move over any tubular section on any wheelchair; a mean which allows to regulate the pressure (2) on the abovementioned securing mean (1); a tubular mean (3), over which a first tubular mean with elongated projection (4), which rotates over said tubular mean (3) and also axially movement, closing over the tubular mean (3) through two (optional) means to regulate the pressure (5); a second tubular mean with elongated projection (6), which interacts through a Connecting mean (7) with the first tubular mean with elongated projection (4), where said second tubular mean with elongated projection (6), holds the support mean of the accessory (8) to be adjusted through the referred universal subjection mechanism. This second tubular mean with elongated projection (6) also closes over the support mean of the accessory (8) through other two optional means to regulate pressure (9).

The absence or presence of stop mean in the means (3), (4), (6) or (8) will depend on the complementary means (3 with 4 and 6 with 8) whether or not having said stop, can it be inserted in (3) when it is not in (4) and vice versa, or present in (6) when it is not in (8) and vice versa. Said stop is present based on the limiting distance translationally or allow axially sliding mean (4) on its complementary (3) and the mean (6) on its complementary (8). FIG. 2 shows all components assembled universal clamping mechanism, specifically all of the same means (1) to (9) are evident in the graph above.

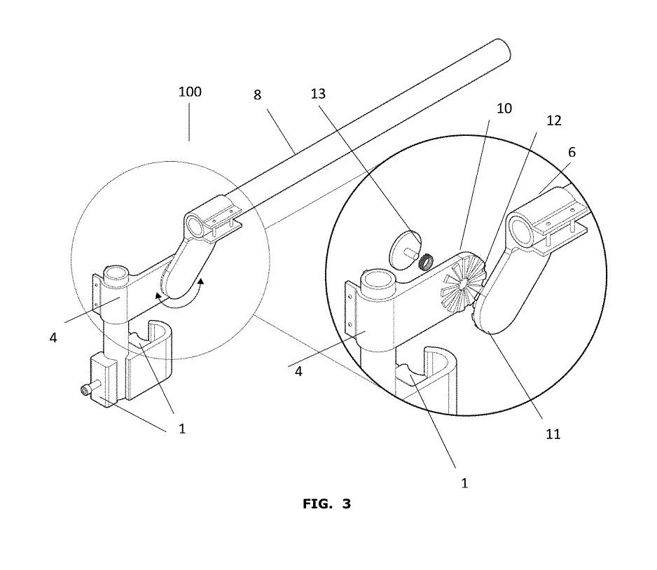

FIG. 3 presents a second embodiment of the invention, where possible variations of the first tubular brace with elongated projection (4) and a second tubular mean with elongated projection (6), where the elongated projections present a higher elongation and in the distal end contemplates a few interlaced double ratchet means (10 y 11). Said first and second tubular brace with elongated projections (4) and (6) allow a better reach of the universal securing mechanism (100) reducing the length of the support mean to accessories (8) in case it is required. The ratchet mean in the first tubular mean (10) fits with the ratchet means of the second tubular mean (11) in certain angular steps determined by the configuration of their teeth (12), allowing to change and adjust the angle of the second tubular mean with elongated projection (6) as the user desires. Other lockup mechanisms similar to the ratchet means are part of the present variation of the invention. The spring mechanism (13) exemplifies the connecting between the two ratchet means (10 and 11) and 10 allows obtaining a system, preferably a button system, by which the user may unlock the mechanism and search for the desired angle.

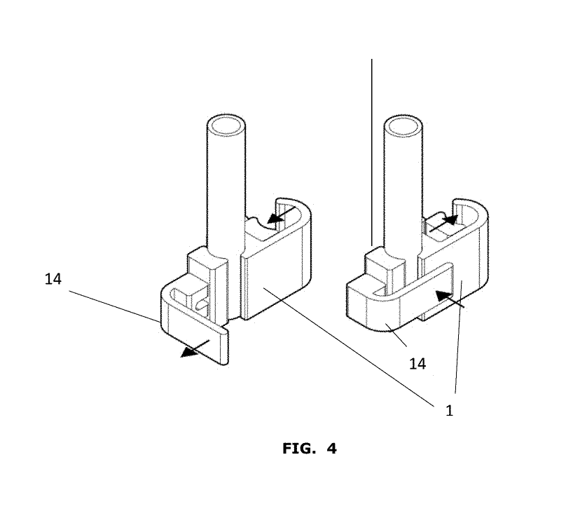

The optional means for pressure (2) and (9), are optional in the sense that, by another embodiment, they may be absent when the respective tubular brace with elongated projection (4) and (6) are welded in their tubular part or connected in any other way that does not require the presence of said means for pressure (2) and (9). Mean (9) to adjust the mechanism is designed in such a way that most users may install the product by themselves. In this sense, in other embodiment of the invention, some mechanical variations are accepted, such as adjustment by automatic lever, screw crank, button with a spring, among others. As an example, FIG. 4 exemplifies an easy-open lever (14) as one of embodiment of the invention in question. This lever works in a similar way as a cam system that when it is rotated the easy open lever (14) pulls the optional mean to regulate the pressure (9), which in this example may be a pin. When the easy-open lever is rotated (14) in the other direction, the pin that replaces the optional mean to graduate pressure (9) is pushed axially and at the same time pushes the securing mean (1), which compresses the tube of the wheelchair in which it is going to be fastened.

In another embodiment of the present invention, the inner surface of the means which have contact with other means that comprise the mechanism, and the inner surface of the means which have contact with the surface of the section of the wheelchair where they are to be adjusted, may be coated with any material that tends to reduce friction among said means and among the means and the section of the wheelchair where the mechanism is to be adjusted, but it should not reduce the pressure neither the gripping effectiveness nor the adjustment among said means, neither among said means and the section of the wheelchair where the mechanism is to be adjusted.

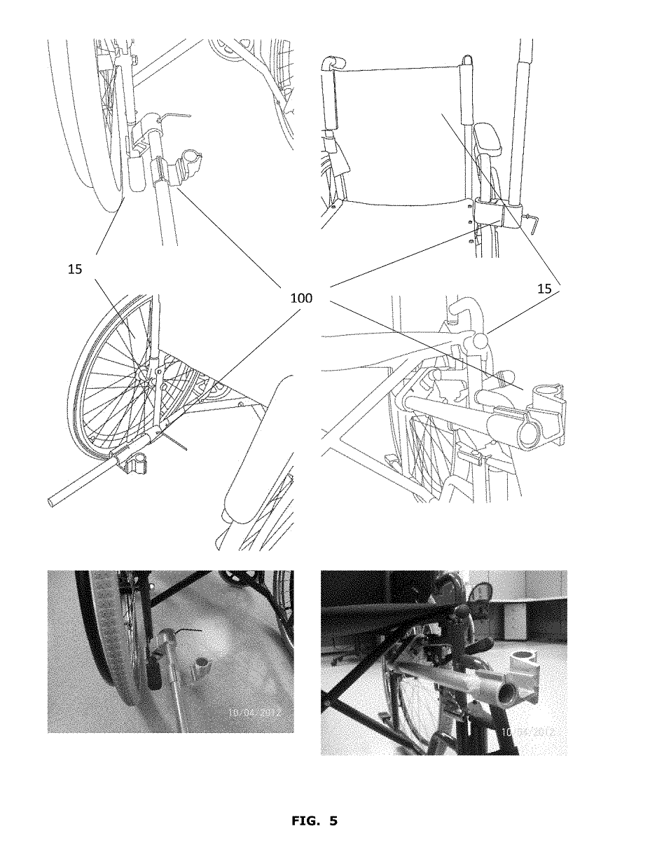

FIG. 5 shows the universal securing mechanism (100) fastened in different tubes of a manual wheelchair (15). The universal securing mechanism (100) should preferably be adjusted in the backrest of the wheelchair; however, it may also be optionally adjusted in other tubes such as the armrest, the footrest, the frame of the wheel and any other tubular artifact that allows its subjection. In addition, in other embodiment of the invention, the universal securing mechanism (100) may be set-up in a different way so that it can be fastened to the tubes of different shapes (squared, triangular, etc).

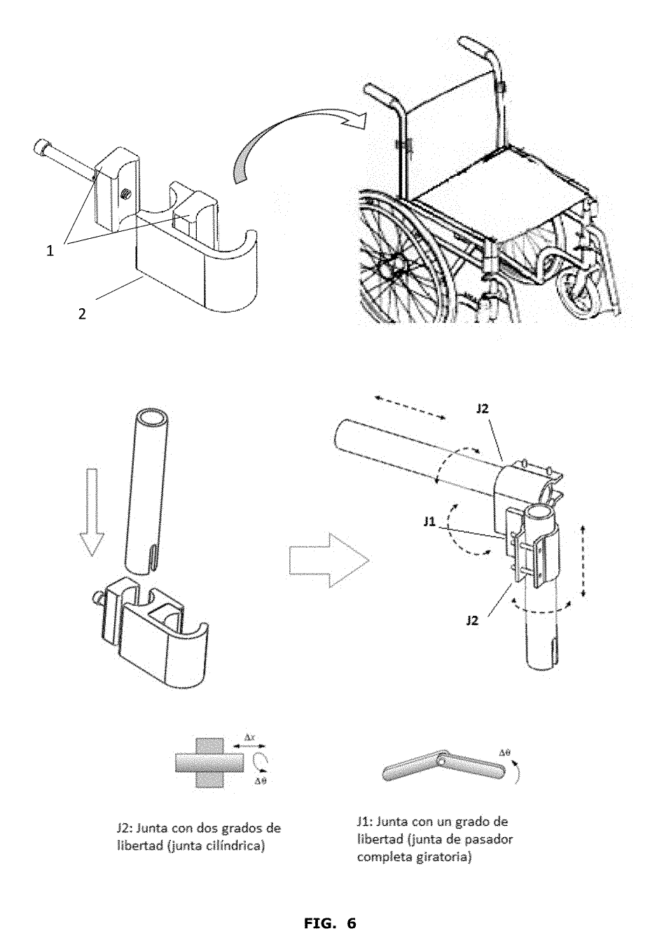

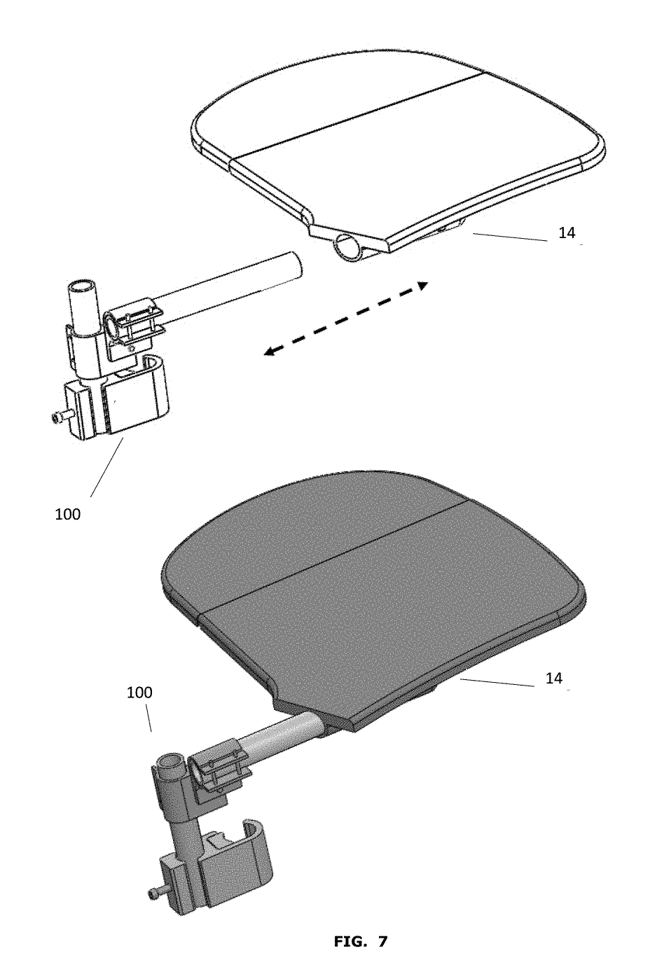

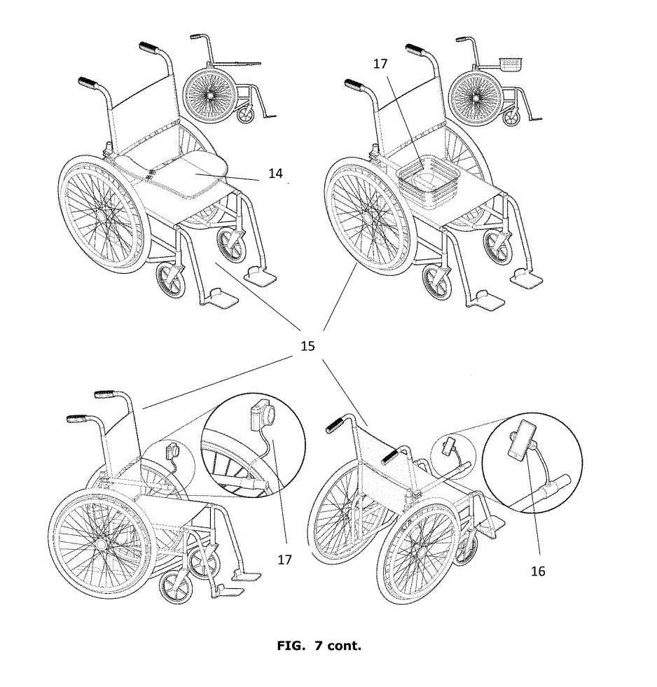

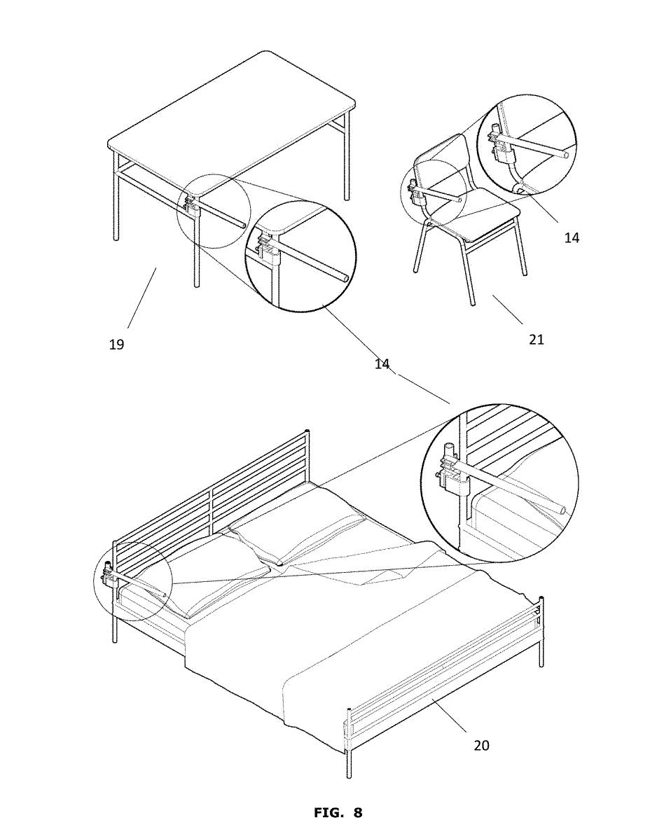

FIG. 6 shows the instructions to place the accessory, in this case a medium lap-tray (16), through the installation of the universal securing mechanism in the tube of the backrest of a wheelchair (15). In addition to a half lap-tray desk (16), it also shows other examples of posture support and accessories such as a grocery basket (17), a cell phone (16) and a photo camera (18). Just like these different postural supports and accessories, the universal securing mechanism (1) may adjust any other accessory or postural support with similar characteristics. FIG. 8 illustrates other similar resting systems where the universal securing mechanism (1) may also be adjusted. Among these, there is an office desk (19), a hospital or home gurney (20) and an office chair (21), with or without wheels. Likewise, the universal securing mechanism (1) may be adjusted to any other resting furnish for the office, studio or other similar places.

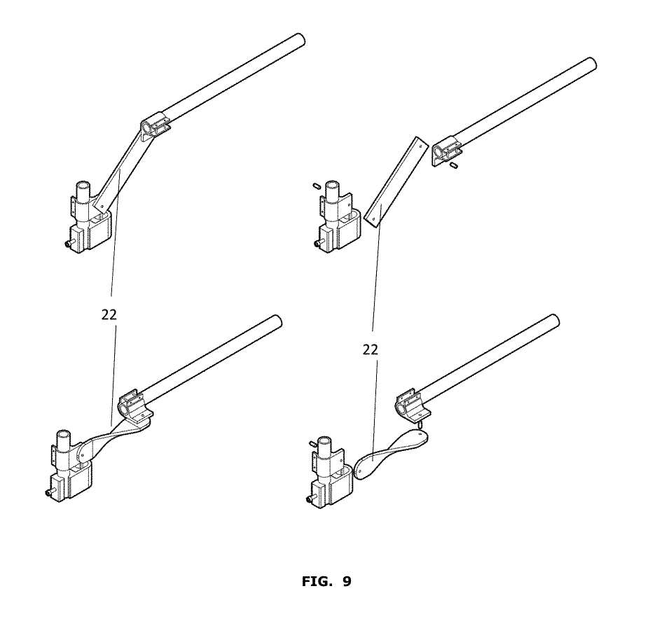

In another embodiment of the invention, the universal securing mechanism (100) may include a third link (22) which connects the first tubular mean with the link, (4) and the second tubular mean with elongated projection (6) as can be evidenced in FIG. 9. Said third link (22) allows a higher elongation of the mechanism and adds one more 10 degree of freedom. Said link (22) may be set-up in a way to add two more degrees of freedom providing rotational movements to the mechanism (this cannot be seen in the figure).

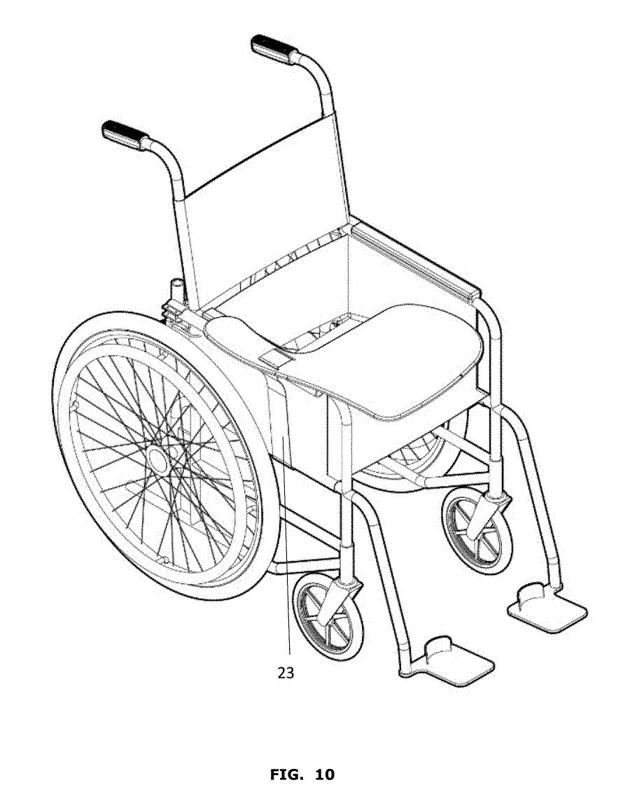

FIG. 10 shows the universal securing mechanism (100) as installed in the backrest of a wheelchair (15) and fastened to the armchair of a wheelchair (15) by means of belts and lariats (23). Said belts or lariats (23) are intertwined in the frame of the wheelchair (15) allowing more adjustment of a postural support such as a lap-tray desk (16). These belts or lariats (23) are also of easy adjustment and release, preferably adjusted with VELCRO® or other adjustment mechanisms. Even in postural supports like a lap-tray desk may be positioned in order to work with or without the universal securing mechanism (100), in a way that if the user wishes to remove the universal securing mechanism (100) to put another postural support in another point of the wheelchair (15), he may do so and the belts or lariats may support the structure of the lap-tray desk (16), as observed in FIG. 10b or 10c.

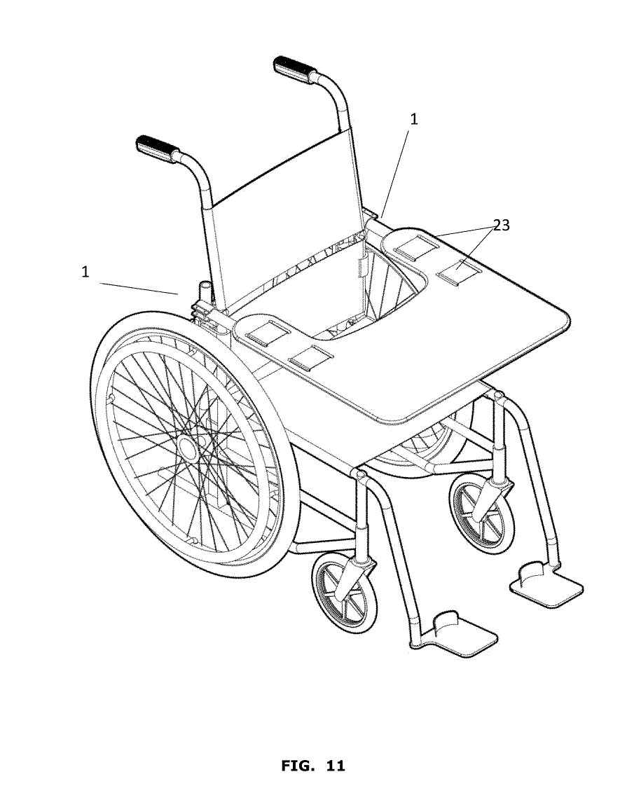

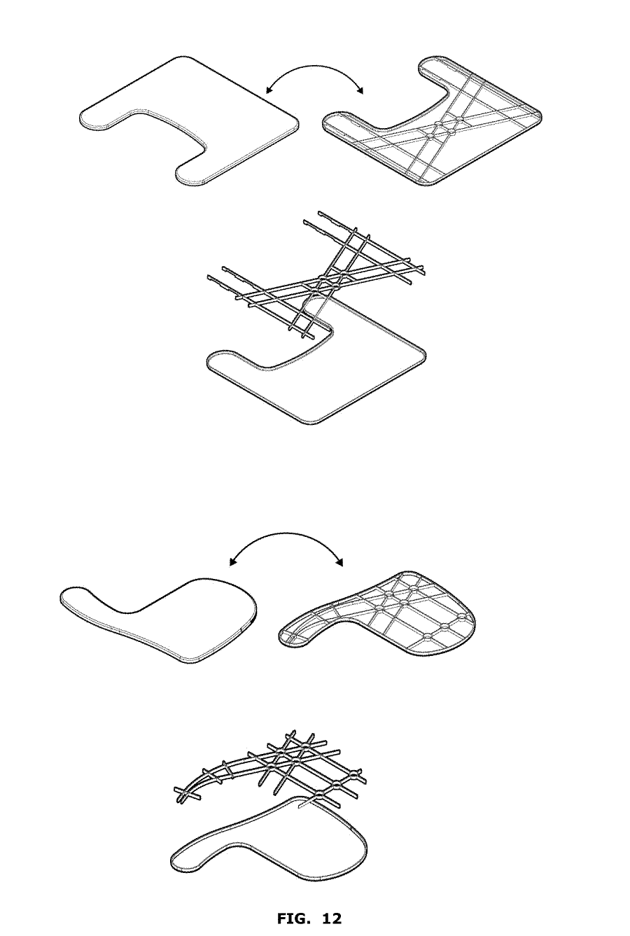

FIG. 11 shows a whole lap-tray desk (24) as postural support positioned by two universal securing mechanisms (1A y 1B) located in the tube of each side of the backrest. Likewise, as a preferred modular adaptation of the present release, FIG. 12 shows two types of postural supports (medium lap-tray desk (16) and whole lap-tray desk (24) with the surface of two ways of realization in a way of connecting postural supports. In one embodiment the surface is thick and smooth (16 and 24) and in another embodiment the surface is thin and with setoff, relief or protrusion net in its lower part, as a mesh (25 y 26). This kind of meshing allows an important reduction of the weight and of manufacture costs.

It is important to highlight that the geometrical shape of some of the designed means, particularly the subjection mean (1), allows a manufacture process by extrusion, which leads to long strips of die making easier to cut into individual means. Later on, said means will be fastened in order to provide them the necessary resistance.

TABLE 1

| | Individual | Individual | | | |
|---|---|---|---|---|---|
| Descrip- | Weight | length | Number of | Tooling | Cost per |
| tion | (Kg) | (m) | pieces | cost | part |
| Pieces | 0.059 | 0.044 | 6.779 | R $4.750.00 | R $0.737 |
| 4 and 6 | | | | COL$ | COL$ |
| | | | | 4.317.750.00 | 670.00 |
| Piece 2 | 0.164 | 0.054 | 2.439 | R $4.900.00 | R $1.952 |
| | | | | COL$ | COL$ |
| | | | | 4.454.100.00 | 1.863.00 |
| Piece 1 | 0.029 | 0.054 | 13.793 | R $4.500.00 | R $0.362 |
| | | | | COL$ | COL$ |
| | | | | 4.090.500.00 | 329.00 |

Prices in May 2012

At the beginning, the materials with which the means may be manufactured would be materials that allow to be extruded, which possess good capacity to be deformed, this means materials that can be elongated. However, if such means are not manufactured through extrusion, the materials may be expanded to those that take the shape of the means through processes such as welding, wrought, cut or any other mechanism that allows to provide a form to the mean.

Included among the used materials are tin, beryllium, zinc, copper, vanadium, led, zirconium, molybdenum, first title brasses 1° (ie. 15% and 30% Zn), aluminum and its alloys (Al-Mg-Si, Al-Cu-Mg, Al-Mg 3); being 10 aluminum preferable, in cold extrusion processes as well as in hot. Other materials that could be used include carbon Steel until C<0,4% calmed and slightly alloyed with Mn, Si, Cr, Ni, Mo. Steels with low carbon and stainless steels may also be used.

### Proof of Concept

In order to prove the effectiveness of the universal subjection mechanism, a static charge was adapted to a half lap-tray desk (16) on a conventional wheelchair (15). The equation of the ANSI-RESNA norm was used to prove the downward resistance after applying static force in the armrest.

F=(S*Md*g)/(2*cos 15)(5)

### Where:

g=Gravity
Md=Applied mass
S=Security factor
F=Applied force in Newtons

The criterion for approval test kit on the system was supporting 50 kg of load. This weight was chosen because it takes into account the weight of a book or a laptop plus a percentage of the weight of the user when tilted on lap-tray. A force gauge was applied to the center of mass of lap-tray.

### Costs/Benefits

In developing countries and in the US, as proposed devices are not covered by health insurance and they must be purchased by the user. The material used (AL 6061-T6) makes the manufacture of this mechanism can be carried out in large quantities, with a cost affordable production. A simple extrusion process, common aluminum in the US and in many other countries, it can be applied without problems for achieving the specific forms of the present mechanism parts. Some parts also require some machining steps (single holes). Adaptation allows various accessories to be attached to a wheelchair.

Access to wheelchairs high quality and funding is limited for people with disabilities in Colombia and the rest of Latin America. Production costs were kept in mind at all times during the preparation of the clamping mechanism described here. All components thereof can all be manufactured as extrusions and some pieces were designed symmetrically to allow interchangeability, as the tubular braces (4 and 6). The goal was that the whole universal clamping mechanism has a cost of USD 10. The estimated cost of the final design was $ 17.

It must be understood that even though the present invention has been specifically released by a preferred embodiment and by optional characteristics. Any modifications, improvements and variations of the invention released in this document may be studied by the experts in the relevant state of the art. In addition, such modifications, improvements and variations are considered to be within the scope of this invention. The materials, methods and examples hereby proportioned are representative of the preferred realizations, which is to say that they are exemplary and are not destined to be limitations to the scope of this invention.

All the publications, patent applications, patents, methods commonly used in commerce and other references appearing in this document are incorporated only by means of reference.

1. A mechanism with the following characteristics
a) One securing mean (1)
b) Mean to regulate the pressure (2)
c) Tubular mean with or without lock (3)
d) First tubular brace with elongated projection, with or without lock (4)
e) Optional mean to regulate pressure (5)
f) Second tubular brace with elongated projection, with or without lock (6)
g) Connection mean (7)
h) Support mean to accessories, with or without lock (8)
i) Means to regulate pressure (9).

2. The mechanism described in claim 1, comprising one securing mean (1) able to rotate and move over every tubular section of any wheelchair; One mean that enable pressure regulation (2) to that securing mean (1); One tubular mean with and without lock (3) on which a tubular brace with elongated projection with or without lock is positioned (4), which move rotationally over this tubular mean (3) and also translational and axially, closing over the tubular mean (3) through two optional means to regulate the pressure (5); a second tubular mean with elongated projection with or without lock (6), which interacts through a connecting mean (7) with the first tubular mean with elongated projection with or without lock (4), where said second tubular mean with elongated projection with or without lock (6), holds the support mean of the accessory (8) to be adjusted through the referred universal subjection mechanism. This second tubular mean with elongated projection with or without lock (6) also closes over the support mean of the accessory (8) through other two optional means to regulate pressure (9).

3. The mechanism described in claim 1, characterized because it has at least 6 degrees of freedom.

4. The mechanism described in claim 1, characterized because the lock of the means (3), (4), (6) and (8) are present in (3) when it is not present in (4) and vice versa, and because is present in (6) when it is not present in (8) and vice versa.

5. The mechanism described in claim 1, characterized because the first and second tubular brace with elongated projection (4) and (6) are welded in their tubular part or otherwise connected in any other way that does not require the presence of said means for exert pressure (2) and (9).

6. The mechanism described in claim 1, characterized because the internal surface of the means that have contact with others means that up the present mechanism, or the internal surface of the means that have contact with the surface of the wheelchair is covered by a material that reduces friction but does not reduce pressure or efficiency to grab or adjust said means or between means and the section of the wheelchair.

7. The mechanism described in claim 1, characterized because these means are made of a list of materials such as, Tin, Beryllium, Zinc, Copper, Vanadium, Lead, Zirconium, Molybdenum, Latones 1 Q title (p.e 15% and 30% Zn), aluminum and its alloys: (Al-Mg-Si, Al-Cu-Mg, Al -Mg 3); Carbon steels up to C<0.4% calm and slightly alloyed with Mn, Si, Cr, Ni, Mo; low carbon steels, stainless steels and combinations of the previous materials.

8. The mechanism described in claim 7, characterized because these means are preferably made of aluminum AL 6061-T6.

9. The mechanism described in claim 1, characterized because these means are manufactured through an extrusion process in hot or cold.

10. The mechanism described in claim 1, where the first tubular brace with elongated projection (4) and the second brace with elongated projection (6) have a higher elongation.

11. The mechanism described in claim 10, where the distal end of the elongated projection of the first and second tubular brace (4) and (6) contemplates a few interlaced double ratchet means (10 and 11).

12. The mechanism described in claim 1, where the optional mean to regulate the pressure (9) has an easy-open lever (14).

13. The mechanism described in claim 1, where a third elongated projection or link (22) connects to the first tubular mean with elongated projection with or without lock (4) and the second tubular mean with elongated projection with or without lock (6), where said third elongated projection or link (22) allows a higher elongation of the mechanism and adds more translational and rotational degrees of freedom.

14. A sitting assistance system, comprises:
a) A wheeled mobility system;
b) At least one universal securing mechanism (1) installed to a tube from the frame of the wheeled mobility system (15); and
c) At least a postural support installed into the universal securing mechanism.

15. The assistance system described in claim 13, where the securing mechanism (1) can be adjusted to different tubes of the wheeled mobility system (15) such as, the frame of the wheel, the back plate, the armrest, the footrest, and any other tubular artifact that allows its subjection.

16. The assistance system described in claim 13, where the postural support could be a mid-table lap-tray, a table, a cell phone's placement accessory, a laptop or tablet table accessory, and similar accessories.

17. The assistance system described in claim 13, where the wheeled mobility system (15) can be replaced with a resting system such as work furniture.

18. The assistance system described in claim 17, where that resting system could be a desk (19), a litter (20), an office chair (21) or similar furniture.

19. The assistance system described in claim 13, where the postural support is adjusted to the securing mechanism (1) and could be additionally adjusted to the armrest by means of belts and lariats (23) to give more stability, where said belts or lariats (23) are intertwined in the frame of the wheeled mobility system.

20. The assistance system described in claim 19, where the postural support could be adjusted to the armrest by means of belts and lariats (23) without the need of the adjustment granted by the securing mechanism.

21. The assistance system described in claim 19, where one or two additional securing mean could be add (1) to the sitting assistance system to give more stability to the postural support or to locate several postural supports in a wheeled mobility system.

22. A postural support, comprising:
a) A surface; and
b) A relief in their lower part, this relief is a mesh that gives a higher stability in the postural support and a reduction of the weight.

23. A postural support in claim 22), where that support could be a mid-table (16) or a complete table (24).
